(19) United States
(12) Patent Application Publication
(10) Pub. No.: US 2005/0035921 A1
(43) Pub. Date: Feb. 17, 2005

(54) SWITCHABLE ANTENNA MATCHING SYSTEM FOR A FLIP STYLE MOBILE PHONE

(76) Inventors: Chao-Chin Huang, Chia-Yi Hsien (TW); Tzeng-Chih Chiou, Taipei Hsien (TW); Chin-Chuan Tai, Taipei Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/710,800

(22) Filed: Aug. 4, 2004

(30) Foreign Application Priority Data
Aug. 11, 2003 (TW) 092121983

(51) Int. Cl. H01Q 1/50

(52) U.S. Cl. 343/860; 343/850

(57) ABSTRACT

An antenna matching system is used in a flip style mobile unit. The flip style mobile unit can be operated in an open status or in a closed status. The antenna matching system includes an antenna for receiving/transmitting an RF signal, a first matching circuit for operating the antenna in a first matching mode, a second matching circuit for operating the antenna in the second matching mode, and a switch for switching the antenna between the first matching mode and the second matching mode according to whether the flip style mobile unit is in the open status or in the closed status.

### BACKGROUND OF INVENTION

1. Field of the Invention

The invention relates to an antenna matching system and related method used in a flip style mobile unit, and more particularly, to an antenna matching system operated in different corresponding matching modes when the flip style mobile unit is in different statuses.

2. Description of the Prior Art

Please refer to FIG. 1, which is a functional block diagram of a typical receiver 10. The receiver 10 includes an antenna 12, a matching circuit 14, and a signal processing module 16. Regarding the signal-receiving processing, the antenna 12 is utilized to receive an RF signal being transmitted in free space, and the antenna 12 can be implemented as a dipole antenna or others. Afterwards, the matching circuit 14 is used to reach sound impedance matching so that the RF signal can be smoothly transmitted to the signal processing module 16 for advanced processing. Due to that the antenna 12 has a specific characteristic impedance when being operated, the impedances of the related transmitting path in the receiver 10 should match that of the antenna 12 so that the signal transmitted form the antenna 12 to the signal processing module 16 of the receiver 10 can be completely maintained. Therefore, the designs of the matching circuit 14 and the antenna 12 are seriously related to the quality of the signal; that is, if the matching circuit 14 does not operate well, part of the signal will be lost due to the impedance mismatch and the sensitivity of the whole system will be reduced.

However, as described in the above-mentioned paragraph, the antenna 12 has different characteristic impedances when being operated in various modes. For instance, a standby mode and a communication mode are alternately adapted in a signal-receiving process in a mobile phone. Generally, when the mobile phone is operated in the standby mode, the antenna of the mobile phone can be operated with higher power in order to ensure the success of signal receiving. On the other hand, when the mobile phone is operated in the communication mode, a near-field electromagnetic radiation of the antenna should conform to a present criterion, a specific value according to an SAR (specific absorption rate) specification. Concerning operations of the flip style mobile phone, the flip style mobile phone shows different characteristics in a closed status (corresponding to the above-mentioned standby mode) and an open status (corresponding to the above-mentioned communication mode). In order to bring the antenna of the flip style mobile phone into full play, the two different statuses (open/closed status) have to be brought into consideration when the flip style mobile phone is designed and implemented.

Please continue to refer to FIG. 1. When implementing the flip style mobile phone, only one matching circuit 14 is not sufficient to achieve the impedance matching in both the closed and open statuses of the flip style mobile phone; that is, the matching circuit 14 cannot meet the requirements in both open and closed statuses. In the general prior-art techniques, the matching circuit 14 is designed to meet requirements (impedance match) of the flip style mobile phone in the open status at the expense of the performance of the flip style mobile phone in the closed status.

### SUMMARY OF INVENTION

It is therefore a primary objective of the claimed invention to provide an antenna matching system installed with at least two matching circuits to operate the antenna in different matching modes when the flip style mobile unit is in different (open/closed) statuses to solve the above-mentioned problem.

In the present invention, we utilize a switch and a control circuit to switch an antenna between two different matching modes respectively when the flip style mobile unit is in open and closed statuses. Each corresponding matching circuit is used to achieve a matching mode so as to reach the optimum performances of the flip style mobile phone in both open and closed statuses.

According to the claimed invention, an antenna matching system used in a flip style mobile unit is disclosed. The flip style mobile unit is operated in a open status or in a closed status, and the antenna matching system comprises an antenna for receiving and transmitting an RF signal, a first matching circuit for operating the antenna in a first matching mode, a second matching circuit for operating the antenna in a second matching mode, and a switch for switching the antenna between the first matching mode and the second matching mode according to whether the flip style mobile unit is in the open status or the closed status.

According to the claimed invention, a method used in a flip style mobile unit for switching an antenna among a plurality of matching modes is disclosed. The plurality of matching modes at least comprise a first matching mode and a second matching mode, and the flip style mobile unit further comprises a switch. The method comprises utilizing the switch to operate the antenna in the first matching mode when the flip style mobile unit is in an open status, and utilizing the switch to operate the antenna in the second matching mode when the flip style mobile unit is in a closed status.

According to the claimed invention, a flip style mobile unit being operated in an open status or a closed status comprises an antenna for receiving and transmitting an RF signal, at least two matching circuits for respectively operating the antenna in a first matching mode and in a second matching mode, a switch for switching the antenna between the first matching mode and the second matching mode, and a control circuit electrically connected to the switch for switching the antenna between the first matching mode and the second matching mode according to whether the flip style mobile unit is in the open status or in the closed status.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of a typical receiver.

FIG. 2 is a schematic diagram of a flip style mobile unit.

FIG. 3 is a functional block diagram of an embodiment of an antenna matching system according to the present invention.

FIG. 4 is a functional block diagram of a detailed embodiment shown in FIG. 3.

FIG. 5 is a flow chart according to the present invention.

FIG. 6 is a functional block diagram of a detailed embodiment shown in FIG. 4.

FIG. 7 is a functional block diagram of another detailed embodiment shown in FIG. 4.

### DETAILED DESCRIPTION

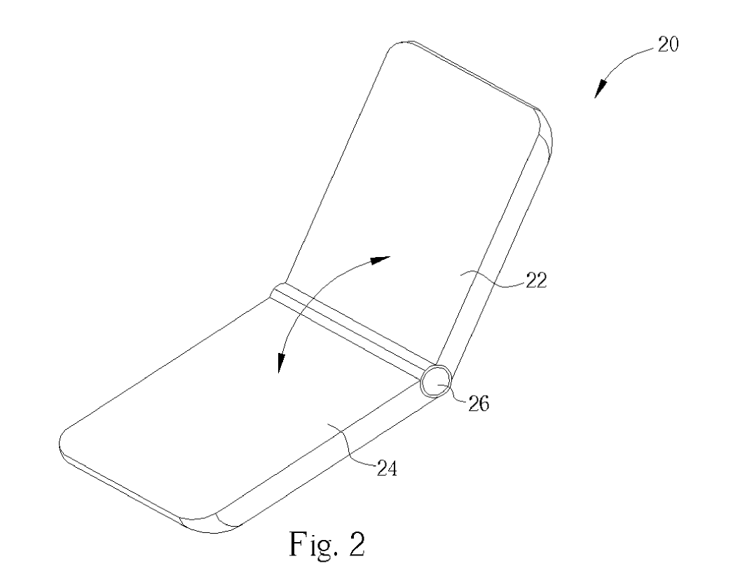

Regarding the structure of a flip style mobile unit of the present invention, please refer to FIG. 2, which is a schematic diagram of a flip style mobile unit 20. The flip style mobile unit 20 includes a first housing 22 and a second housing 24. The flip style mobile unit 20 further includes a hinge 26, and the first housing 22 is rotatably connected to the second housing 24 around the pivot of the hinge 26. When the first housing 22 joins with the second housing 24, the flip style mobile unit 20 is in the closed status; when the first housing 22 separates from the second housing 24, the flip style mobile unit 20 is in the open status. When being practically implemented, the flip style mobile unit 20 can be a flip style mobile phone.

Please notice that FIG. 2 only shows an embodiment of the flip style mobile unit 20, and the characteristics of the present can be applied to the flip style mobile unit of other types.

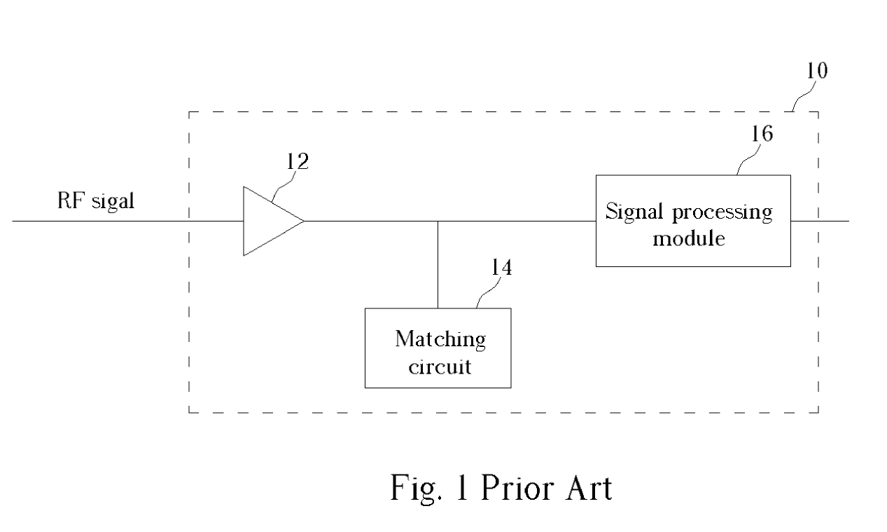

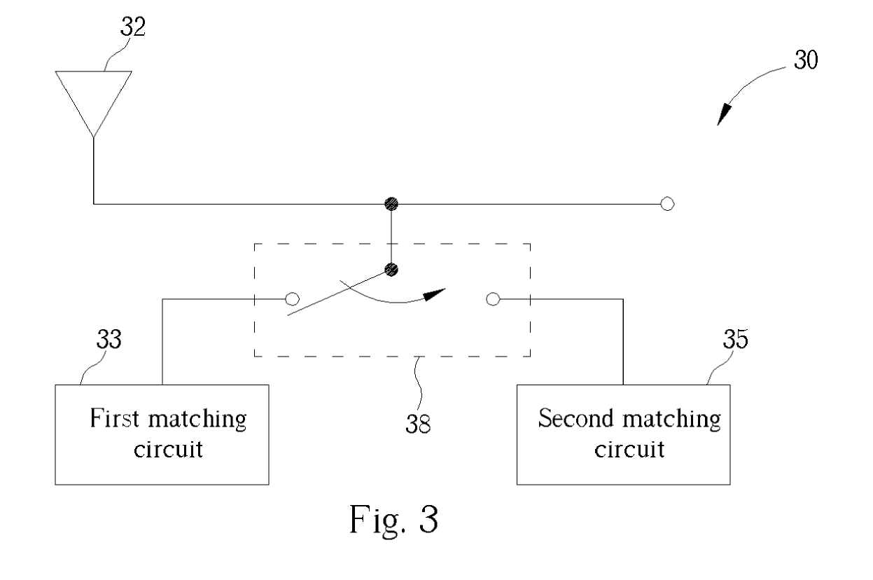

Please refer to FIG. 3, which is a functional block diagram of an embodiment of an antenna matching system 30 according to the present invention. The antenna matching system 30 is mainly applied to the flip style mobile unit 20 shown in FIG. 2, and the antenna matching system 30 includes an antenna 32, a first matching circuit 33, a second matching circuit 35, and a switch 38. The antenna 32 is used to receive and to transmit an RF signal. The first matching circuit 33 can be used to operate the antenna 32 in a first matching mode, while the second matching circuit 35 can be used to operate the antenna 32 in a second matching mode. In the present embodiment, the first matching circuit 33 and the second matching circuit 35 are not directly connected to the antenna 32 with the switch 38 as a mediator. The switch 38 can be used to switch the antenna between the first matching mode and the second matching mode according to whether the flip style mobile unit 20 is in the open status or in the closed status. When being implemented, in the open status, the switch 38 connects the first matching circuit 33 with the antenna 32 so that the signal is transmitted through the first matching circuit 33 and the antenna 32 will be in first matching mode. When the flip style mobile unit 20 is in the closed status, the switch 38 connects the second matching circuit 35 with the antenna 32 so that the signal is transmitted through the second matching circuit 35 and the antenna 32 will be switched to the second matching mode. The first matching circuit 33 can be used to achieve the optimum impedance-matching performance of the flip style mobile unit 20 in the open status while the second matching circuit 35 can be used to achieve the optimum impedance-matching performance of the flip style mobile unit 20 in the closed status. In contrast to the prior-art embodiment shown in FIG. 1, the present embodiment makes use of an additional matching circuit (the second matching circuit 35) to optimize the impedance-matching performance of the flip style mobile unit 20 in the closed status.

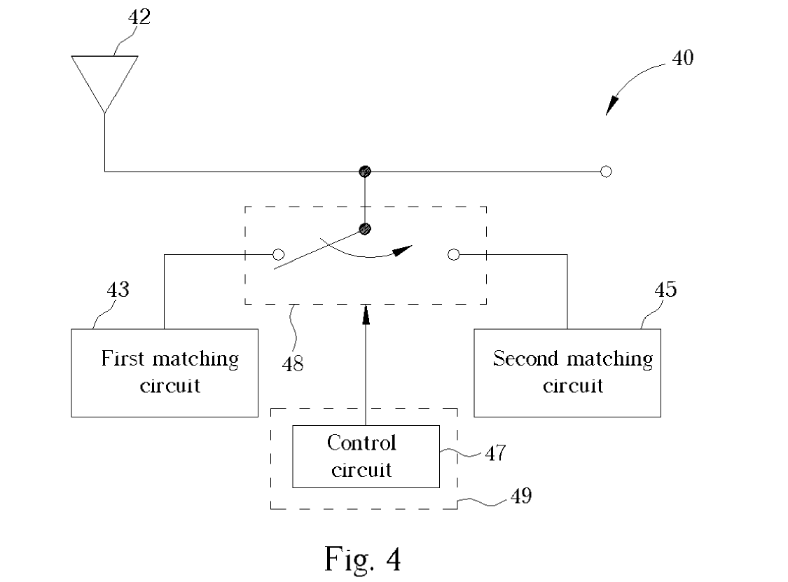

Please refer to FIG. 4, which is a functional block diagram of a detailed embodiment shown in FIG. 3. The antenna matching system 40 includes an antenna 42, a first matching circuit 43, a second matching circuit 45, and a switch 48. In the present embodiment, the antenna matching system 40 further includes a control circuit 47 and a sensor 49 electrically connected to the switch 48 for controlling operations of the switch 48. The sensor 49 is used to detect if the first housing 22 joins with the second housing 24 shown in FIG. 2. The control circuit 47 can be included in the sensor 49 or installed outside of the sensor 49 (in the present embodiment, the control circuit 47 is included in the sensor 49). When the flip style mobile unit 20 is in the open status, the control circuit 47 will be used to control the switch 48 to connect the first matching circuit 43 with the antenna 42. On the other hand, when the flip style mobile unit 20 is in the closed status, the control circuit 47 will be used to control the switch 48 to connect the second matching circuit 45 with the antenna 42. Therefore, the antenna 42 can be switched between the first and the second matching mode.

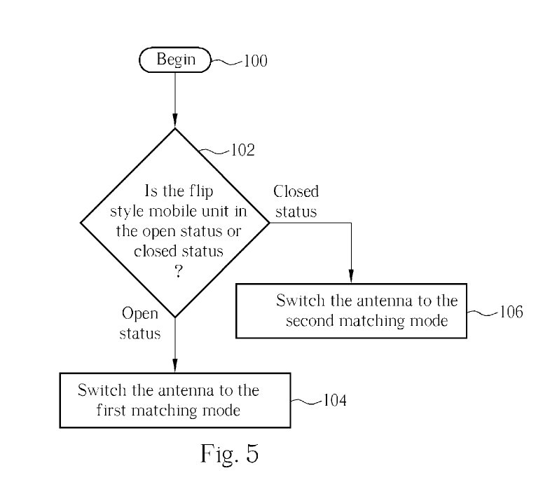

According to the embodiments shown in FIG. 2 to FIG. 4, a method of the present invention used in a flip style mobile unit 20 for switching the antenna 42 shown in FIG. 4 among a plurality of matching modes can be summarized into following steps. Please refer to FIG. 5, which is a flow chart according to the present invention.

Step 100: Begin;

Step 102: utilize the sensor 49 (or the control circuit 47) to detect statuses of the flip style mobile unit 20 (the open status or the closed status). When the flip style mobile unit 20 is in the open status, proceed with Step 104; when the flip style mobile unit 20 is in the closed status, proceed with Step 106;

Step 104: When the flip style mobile unit 20 is in the open status, utilize the control circuit 47 to control the switch 48 to switch the antenna 42 to the first matching mode. In the embodiments shown in FIG. 3 and FIG. 4, the switch 48 will connect the first matching circuit 43 with the antenna 42 so as to switch the antenna 42 to the first matching mode;

Step 106: When the flip style mobile unit 20 is in the closed status, utilize the control circuit 47 to control the switch 48 to switch the antenna 42 to the second matching mode. In the embodiments shown in FIG. 3 and FIG. 4, the switch 48 will connect the second matching circuit 45 with the antenna 42 so as to switch the antenna 42 to the second matching mode.

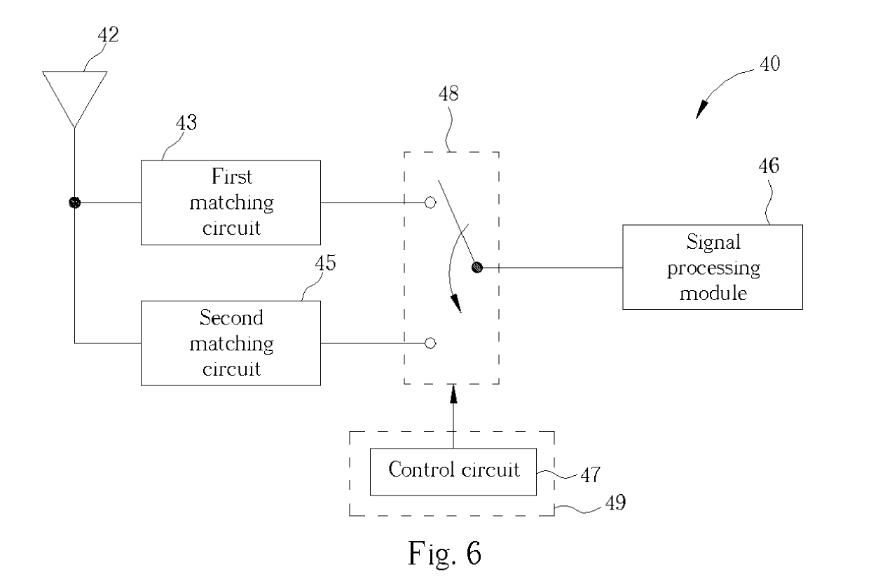

Please refer to FIG. 6, which is a functional block diagram of a detailed embodiment shown in FIG. 4 with an additional signal processing module 46. In the present embodiment, the switch 48 is installed between the signal processing module 46 and the two matching circuits. When the sensor 49 detects that the flip style mobile unit 20 is in the open status, the control circuit 47 will used to control the switch 48 to connect the first matching circuit 43 with the signal processing module 46 so that the signal is transmitted only through the first matching circuit 43 and the antenna 42 is operated in the first matching mode; that is, the first matching circuit 43 can achieve the optimum impedance-matching performance of the flip style mobile unit 20 in the open status. Similarly, when the flip style mobile unit 20 is in the closed status, the control circuit 47 will be used to control the switch 48 to connect the second matching circuit 45 with the signal processing module 46 so that the signal is transmitted only through the second matching circuit 45 and the antenna 42 is operated in the second matching mode.

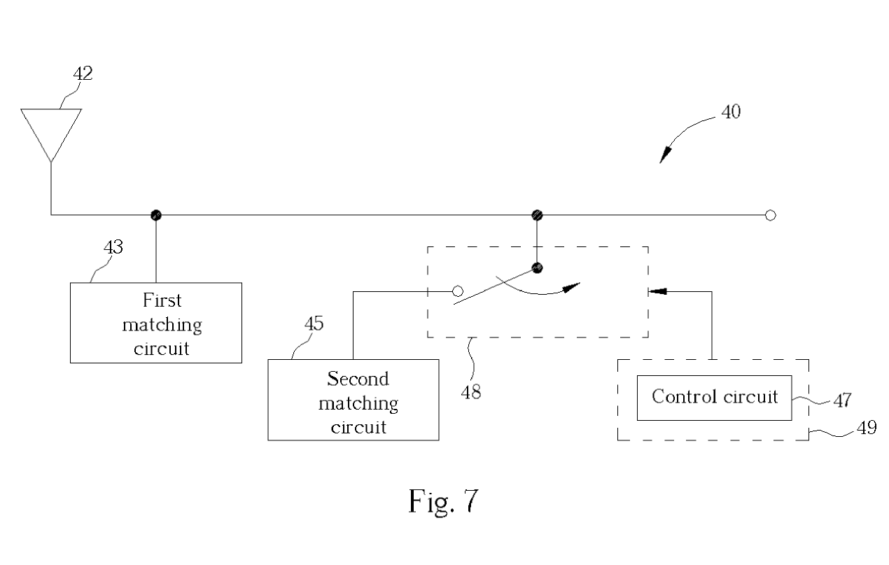

In the embodiments according to the present invention, two matching circuits (first and the second matching circuit) are used respectively for achieving the optimum impedance-matching performances in both statuses (open/closed). Actually, when being practically implemented, the amount of the matching circuit should not be limited. Please refer to FIG. 7, which is a functional block diagram of another detailed embodiment shown in FIG. 4. In the present embodiment, the switch 48 is only connected to the second matching circuit 45. When the flip style mobile unit 20 is in the open status, the control circuit 47 will be used to control the switch 48 not to connect the second matching circuit 45 with the antenna 42, so that the signal is transmitted only through the first matching circuit 43 and the antenna 42 is operated in the first matching mode. When the flip style mobile unit 20 is in the closed status, the switch 48 will be used to connect the second matching circuit 45 with the antenna 42, so that the signal is transmitted through both the first matching circuit 43 and the second matching circuit 45 and the antenna 42 is operated in the second matching mode; that is, the second matching mode is achieved by both the first matching circuit 43 and the second matching circuit 45. In the second matching mode, the flip style mobile unit 20 has the optimum impedance-matching performance in the closed status.

In the present invention, we utilize a switch and a control circuit to switch an antenna between two different matching modes respectively when the flip style mobile unit is in open and closed statuses. Each corresponding matching circuit is used to achieve a matching mode so as to reach the optimum performances of the flip style mobile phone in both open and closed statuses. Moreover, the sensitivity of the flip style mobile phone can be raised while the power loss can be reduced under the characteristics of the present invention.

Those skilled in the art will readily observe that numerous modifications and alterations of the device may be made while retaining the teachings of the invention. Accordingly, that above disclosure should be construed as limited only by the metes and bounds of the appended claims.

1. An antenna matching system used in a flip style mobile unit, the flip style mobile unit being selectively operated in an open status and a closed status, the antenna matching system comprising:
an antenna for receiving and transmitting an RF signal;
a first matching circuit for operating the antenna in a first matching mode;
a second matching circuit for operating the antenna in a second matching mode; and
a switch for switching the antenna between the first matching mode and the second matching mode according to whether the flip style mobile unit is in the open status or the closed status.

2. The antenna matching system of claim 1 further comprising a control circuit electrically connected to the switch for controlling operations of the switch; when the flip style mobile unit is in the open status, the control circuit utilizing the switch to connect the first matching circuit with the antenna to operate the antenna in the first matching mode; when the flip style mobile unit is in the closed status, the control circuit utilizing the switch to connect the second matching circuit with the antenna so as to operate the antenna in the second matching mode.

3. The antenna matching system of claim 2 wherein the flip style mobile unit further comprises a signal processing module; when the flip style mobile unit is in the open status, the control circuit utilizes the switch to connect the first matching circuit with the signal processing module to operate the antenna in the first matching mode; when the flip style mobile unit is in the closed status, the control circuit utilizes the switch to connect the second matching circuit with the signal processing module to operate the antenna in the second matching mode.

4. The antenna matching system of claim 1 wherein the flip style mobile unit further comprises a first housing and a second housing, and the first housing is detachably connected to the second housing.

5. The antenna matching system of claim 4 wherein when the first housing joins with the second housing, the flip style mobile unit is in the closed status; when the first housing separates from the second housing, the flip style mobile unit is in the open status.

6. The antenna matching system of claim 5 wherein the flip style mobile unit further comprises a sensor for detecting whether the first housing joins with or separates from the second housing.

7. The antenna matching system of claim 1 wherein the flip style mobile unit is a flip style mobile phone.

8. A method used in a flip style mobile unit for switching an antenna among a plurality of matching modes, the plurality of matching modes at least comprising a first matching mode and a second matching mode, the flip style mobile unit further comprising a switch, the method comprising:
utilizing the switch to operate the antenna in the first matching mode when the flip style mobile unit is in an open status; and
utilizing the switch to operate the antenna in the second matching mode when the flip style mobile unit is in a closed status.

9. The method of claim 8 wherein the flip style mobile unit further comprises a first matching circuit and a second matching circuit, the method further comprising:
utilizing the switch to connect the first matching circuit with the antenna so as to operate the antenna in the first matching mode when the flip style mobile unit is in the open status; and
utilizing the switch to connect the second matching circuit with the antenna so as to operate the antenna in the second matching mode when the flip style mobile unit is in the closed status.

10. The method of claim 9 wherein the flip style mobile unit further comprises a signal processing module, the method further comprising:
utilizing the switch to connect the first matching circuit with the signal processing module to operate the antenna in the first matching mode when the flip style mobile unit is in the open status; and
utilizing the switch to connect the second matching circuit with the signal processing module so as to operate the antenna in the second matching mode when the flip style mobile unit is in the closed status.

11. The method of claim 8 wherein the flip style mobile unit further comprises a control circuit electrically connected to the switch for controlling operations of the switch.

12. The method of claim 8 wherein the flip style mobile unit further comprises a first housing and a second housing, and the first housing is detachably connected to the second housing.

13. The method of claim 12 wherein when the first housing joins with the second housing, the flip style mobile unit is in the closed status; when the first housing separates from the second housing, the flip style mobile unit is in the open status.

14. The method of claim 13 wherein the flip style mobile unit further comprises a sensor for detecting whether the first housing joins with or separates from the second housing.

15. The method of claim 14 wherein the sensor is electrically connected to the switch for controlling operations of the switch.

16. The method of claim 8 wherein the flip style mobile unit is a flip style mobile phone.

17. A flip style mobile unit being operated in an open status or a closed status, the flip style mobile unit comprising:
an antenna for receiving and transmitting an RF signal;
at least two matching circuits for respectively operating the antenna in a first matching mode and in a second matching mode;
a switch for switching the antenna between the first matching mode and the second matching mode; and
a control circuit electrically connected to the switch for switching the antenna between the first matching mode and the second matching mode according to whether the flip style mobile unit is in the open status or in the closed status.

18. The flip style mobile unit of claim 17 wherein the two matching circuits comprise a first matching circuit and a second matching circuit; when the flip style mobile unit is in the open status, the control circuit utilizes the switch to connect the first matching circuit with the antenna so as to operate the antenna in the first matching mode; when the flip style mobile unit is in the closed status, the control circuit utilizes the switch to connect the second matching circuit with the antenna so as to operate the antenna in the second matching mode.

19. The flip style mobile unit of claim 18 further comprising a signal processing module for processing the RF signal; when the flip style mobile unit is in the open status, the control circuit utilizing the switch to connect the first matching circuit with the signal processing module so as to operate the antenna in the first matching mode; when the flip style mobile unit is in the closed status, the control circuit utilizing the switch to connect the second matching circuit with the signal processing module so as to operate the antenna in the second matching mode.

20. The flip style mobile unit of claim 17 further comprising a first housing and a second housing, the first housing being detachably connected to the second housing.

21. The flip style mobile unit of claim 20 wherein when the first housing joins with the second housing, the flip style mobile unit is in the closed status; when the first housing separates from the second housing, the flip style mobile unit is in the open status.

22. The flip style mobile unit of claim 21 further comprising a sensor for detecting whether the first housing joins with or separates from the second housing.

23. The flip style mobile unit of claim 17 being a flip style mobile phone.
